(19) United States
(12) Patent Application Publication
(10) Pub. No.: US 2007/0085015 A1
(43) Pub. Date: Apr. 19, 2007

(54) LIGHTWEIGHT AND RUGGED DIGITAL X-RAY DETECTOR

(76) Inventor: Donald Earl Castleberry, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/163,336

(22) Filed: Oct. 14, 2005

(51) Int. Cl. G01T 1/24

(52) U.S. Cl. 250/370.09

(57) ABSTRACT

An x-ray detector, which is portable, light, and rugged, includes layers of foam that encase its imaging panel. The electronics are situated outside the footprint of the imaging components. The components of the detector are housed within an impact-absorbing cover assembly.

### BACKGROUND OF THE INVENTION

The present invention relates generally to x-ray detectors and, more particularly, to a cover assembly for a digital radiographic x-ray detector capable of absorbing high-energy impacts to inhibit fracturing of the internal components of the x-ray detector.

X-ray imaging is a non-invasive technique to capture images of medical patients for clinical diagnosis as well as inspect the contents of sealed containers, such as luggage, packages, and other parcels. To capture these images, an x-ray source irradiates a scan subject with a fan beam of x-rays. The x-rays are then attenuated as they pass through the scan subject. The degree of attenuation varies across the scan subject as a result of variances in the internal composition of the subject. The attenuated energy impinges upon an x-ray detector designed to convert the attenuating energy to a form usable in image reconstruction. A control system reads out electrical charge stored in the x-ray detector and generates a corresponding image. For a conventional, screen film detector, the image is developed on a film and displayed using a backlight.

Increasingly, flat panel, digital x-ray detectors are being used to acquire data for image reconstruction. Flat panel detectors are generally constructed as having a scintillator which is used to convert x-rays to visible light that can be detected by a photosensitive layer. The photosensitive layer includes an array of photosensitive or detector elements that each store electrical charge in proportion to the light that is individually detected. Generally, each detector element has a light sensitive region and a region comprised of electronics to control the storage and output of electrical charge. The light sensitive region is typically composed of a photoconductor, and electrons are released in the photoconductor when exposed to visible light. During this exposure, charge is collected in each detector element and is stored in a capacitor situated in the electronics region. After exposure, the charge in each detector element is read out using logic controlled electronics.

Each detector element is conventionally controlled using a transistor-based switch. In this regard, the source of the transistor is connected to the capacitor, the drain of the transistor is connected to a readout line, and the gate of the transistor is connected to a scan control interface disposed on the electronics in the detector. When negative voltage is applied to the gate, the switch is driven to an OFF state, i.e. no conduction between the source and drain. On the other hand, when a positive voltage is applied to the gate, the switch is turned ON resulting in connection of the source to the drain. Each detector element of the detector array is constructed with a respective transistor and is controlled in a manner consistent with that described below.

Specifically, during exposure to x-rays, negative voltage is applied to all gate lines resulting in all the transistor switches being driven to or placed in an OFF state. As a result, any charge accumulated during exposure is stored in each detector element capacitor. During read out, positive voltage is sequentially applied to each gate line, one gate line at a time. That is, the detector is an x-y matrix of detector elements and all of the gates of the transistors in a line are connected together so that turning ON one gate line simultaneously reads out all the detector elements in that line. In this regard, only one detector line is read out at a time. A multiplexer may also be used to support read out of the detector elements in a raster fashion. An advantage of sequentially reading out each detector element individually is that the charge from one detector element does not pass through any other detector elements. The output of each detector element is then input to a digitizer that digitizes the acquired signals for subsequent image reconstruction on a per pixel basis. Each pixel of the reconstructed image corresponds to a single detector element of the detector array.

As described above, indirect detection, digital x-ray detectors utilize a layer of scintillating material, such as Cesium iodide (CsI), to convert incident radiation to visible light that is detected by light sensitive regions of individual detector elements of a detector array. Generally, the transistor controlled detector elements are supported on a thin substrate of glass. The substrate, which supports the detector elements as well as the scintillator layer, is supported by a panel support. The support panel is not only designed to support the detector components, but also isolates the electronics for controlling the detector from the detector components. The electronics are supported by the base of a cover assembly enclosing the internal components of the x-ray detector.

This conventional layered construction results in a relatively heavy and thick x-ray detector, which can be particularly problematic for portable x-ray detector designs. That is, the support panel that mechanically isolates the imaging components from the readout electronics is relatively heavy and thick. However, heretofore, the relatively thick support panel has been required for portable x-ray detectors to prevent fracture of the imaging components when subjected to a patient load, e.g., placed directly beneath a patient being imaged, as well as to prevent the readout electronics from being pressed into the imaging components when subjected to such a load, but at a cost of increased size, weight, and thickness of the x-ray detector.

Additionally, as described above, conventional x-ray detectors are constructed such that the readout electronics and other electronics, e.g., motherboard, of the detector are disposed on a layer that sits beneath the imaging component layers. A drawback of this construction is that during data acquisition, and particularly applicable during higher dose acquisitions, x-rays may pass through the detector layer, glass substrate, panel support, and motherboard. These x-rays then reflect back off of whatever is found behind the glass substrate, e.g., the readout electronics. This phenomenon is generally referenced “backscatter” and can introduce artifacts into the reconstructed image. That is, the “backscattered” x-rays may be detected by the scintillator, converted to light, and detected by the photosensitive regions in the detector elements. As a result, the reconstructed image may include features of the detector electronics and/or panel support, and create an image artifact, which may be misdiagnosed by the radiologist or inspector in discerning the internal make-up of the subject or object.

Therefore, it would be desirable to design an x-ray detector that is less susceptible to backscatter effects, and is light and relatively thin, yet, rugged.

### BRIEF DESCRIPTION OF THE INVENTION

The present invention is directed to an x-ray detector that overcomes the aforementioned drawbacks. The x-ray detector, which is portable, light, and rugged, includes layers of foam that encase its imaging components. The relatively thick and heavy panel support of conventional x-ray detectors has been replaced with a thin and lightweight plate. Moreover, the electronics are situated outside the footprint of the imaging components.

Therefore, in accordance with one aspect of the invention, an x-ray detector is disclosed. The detector includes an imaging panel configured to output electrical signals in response to reception of x-rays and a pair of shock absorbent layers with the imaging panel sandwiched therebetween. A cover assembly is provided for enclosing the imaging panel and the pair of shock absorbent layers.

In accordance with another aspect, the present invention includes a solid state x-ray detector having a scintillator layer configured to output light in response to x-ray exposure and an array of photosensitive detector elements supported by a glass substrate and configured to store electrical charge as a function of light output by the scintillator layer during data acquisition and output electrical signals indicative of the stored electrical charge during readout. The detector further includes a readout electronics board situated outside a footprint of the glass substrate and operatively coupled to the array of photosensitive detector elements.

According to yet another aspect of the invention, a cover assembly to encase components of an x-ray detector is presented. The cover assembly has a top support panel and a bottom support panel. The cover assembly further has an imaging pane formed on the top support panel. The imaging pane defines a perimeter region and a central region of the top support panel. And, at least one of the top support panel and the bottom support panel is formed of x-ray transparent, graphite fiber-epoxy composite that is thicker in the perimeter region than in the central region.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a pictorial view of an exemplary mobile x-ray imaging system.

FIG. 2 is a schematic block diagram of the exemplary x-ray imaging system shown in FIG. 1.

FIG. 3 is a perspective view of a portable, solid-state, flat panel, digital x-ray detector according to one aspect of the present invention.

FIG. 4 is an exploded view of the x-ray detector shown in FIG. 3.

FIG. 5 is a cross-sectional view of a x-ray detector according to another aspect of the present invention.

### DETAILED DESCRIPTION OF THE PREFERRED EMBODIMENT

The present invention will be described with respect to a flat panel, solid-state, indirect detection, portable digital x-ray detector for use with a mobile x-ray imaging system. However, the present invention is equivalently applicable with other types of x-ray detectors including direct detection digital detectors. Additionally, the present invention may be used with stationary or fixed room x-ray imaging systems. Further, the present application makes reference to an imaging “subject” as well as an imaging “object”. These terms are not mutually exclusive and, as such, use of the terms is interchangeable and is not intended to limit the scope of the appending claims.

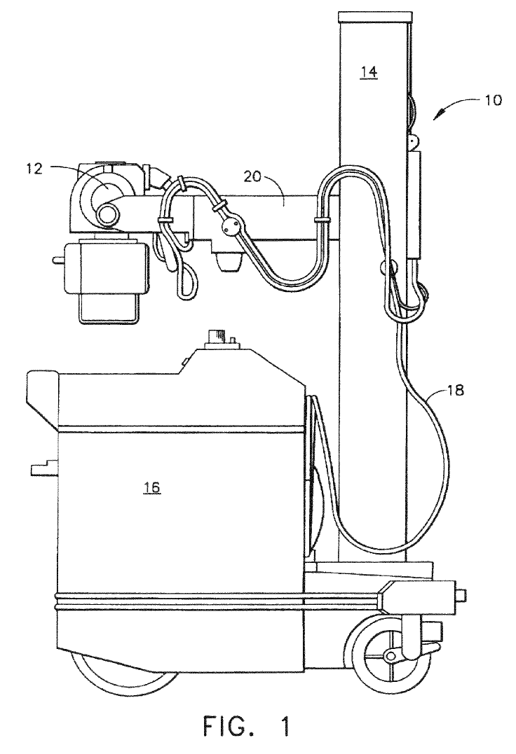

Referring now to FIG. 1, an exemplary mobile x-ray imaging system 10 applicable with a portable x-ray detector incorporating the present invention is shown. An x-ray source 12 is mounted or otherwise secured to an end of horizontal arm 20. Arm 20 allows the x-ray source 12 to be variably positioned above a subject in such a manner so as to optimize irradiation of a particular area of interest. The x-ray source 12 is typically mounted through a gimbal-type arrangement (not shown) in column 14. In this regard, the x-ray source may be rotated vertically from a rest or park position on the mobile x-ray unit base 16 to the appropriate position above the subject in order to take an x-ray exposure of the subject. The rotational movement of column 14 is typically limited to a value of 360 degrees or less to prevent entanglement of high voltage cables 18 used to provide electrical power to the x-ray source 12. Cables 18 may be connected to a utility line source (not shown) or a battery (not shown) in the base 16 to energize the x-ray source 12 as well as other electronic components of the system 10. One skilled in the art will appreciate that system 10 may be equipped or connectable to a display unit (not shown) for the display of images captured from the imaging subject.

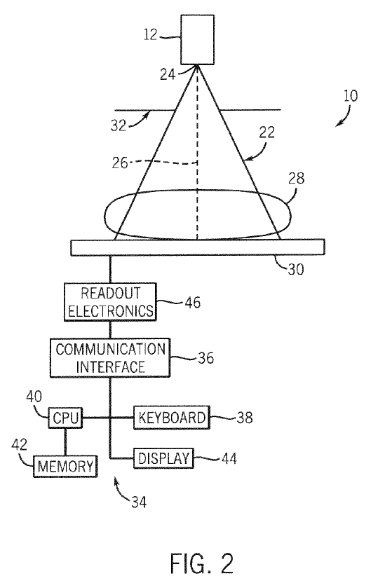

Referring now to FIG. 2, a schematic of x-ray imaging system 10 is illustrated. As referenced above, system 10 includes x-ray source 12 designed to project a fan bean of irradiation 22 from focal spot 24 along axis 26 toward an object to be imaged 28. One skilled in the art will appreciate that medical patients as well as luggage, packages, and the like may be non-invasively inspected using the exemplary x-ray imaging system 10. A flat panel digital detector 30 detects x-rays passing through and attenuated by object 28. A collimator assembly 32, schematically shown in FIG. 2 as comprising collimator blades, may be used to collimate the x-ray fan beam 22 to control the scope of irradiation.

A host or scanner interface 34 includes a communication interface 36, a keyboard 38 or other data entry device, a CPU 40, memory 42, and a display unit 44, such a computer monitor, to display reconstructed images of the object. A bus 46 connects the keyboard 38, CPU 40, memory 42, and display unit 44 to the communication interface 36. The CPU may include a microprocessor, digital signal processor, microcontroller, as well as other devices designed to carry out logic and processing operations. Signals corresponding to an x-ray image are read out from flat panel detector 30 via readout electronics 46. While not shown, it is contemplated that the host interface 34 may be connected to a centralized facility via the Internet or communications link for monitoring and maintenance.

Additionally, the readout electronics may read out signals from the flat panel detector across a tethered connection between the detector and the imaging system. It is also contemplated that read out may be achieved across a wireless communication between the detector and imaging system. In this regard, one skilled in the art will appreciate that the imaging system and detector may be equipped with transceivers, antennas, and other operational circuitry to support the wireless transmission of data.

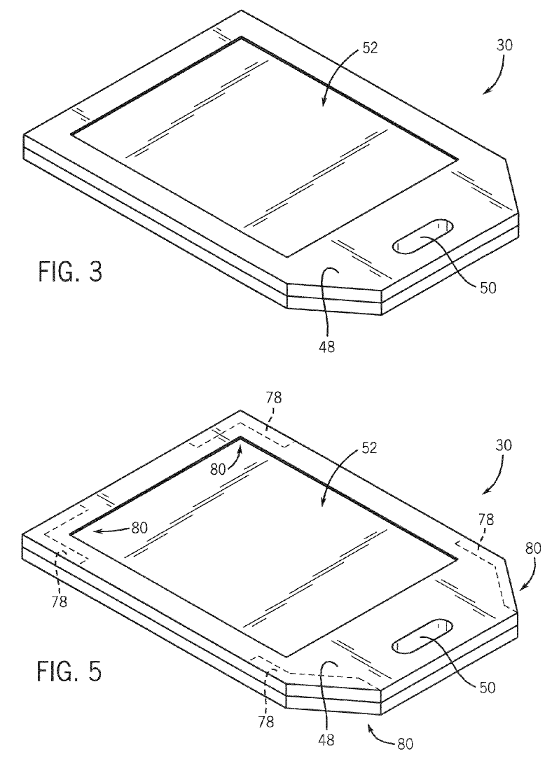

Referring now to FIG. 3, a perspective view illustrates a portable, flat panel x-ray detector 30 incorporating the present invention. Detector 30 is preferably an indirect detection, solid-state, digital detector that determines x-ray attenuation through an imaging subject from the emission of light by a scintillator that emits light upon the incidence of x-rays. The detector 30 includes a cover 48 formed of lightweight, durable composite material. A handle 50 is incorporated into the cover to support the portability of the detector. As shown, the detector 30 may be constructed without a fixed tether. In this regard, the detector may be connected to a tether (not shown), which is connected to the readout electronics when in use. When not in use, the detector may be easily detached from tether and stored remotely from the imaging system. The top of the cover includes a template or imaging pane 52 that visually defines the surface dimensions of the scintillator layer and other components of the imaging panel in the detector. Template 52 is designed to visually assist a user in positioning of the detector for data acquisition and also demarcates the perimeter region (outside the imaging pane) from the central region (inside the imaging pane) of the detector.

While the present invention is particularly applicable with indirect detection digital detectors, the present invention may also be implemented with direct detection digital detectors. Direct detection digital detectors utilize a layer of amorphous selenium or similar material photoconductor coupled to a thin film transistor array. X-ray interaction in the selenium layer releases electrons (or electron holes), which are used to form signal directly. An electrode is often used to create an electric field across the selenium layer to minimize the lateral spread of electrons, preserving spatial resolution. In addition to selenium, mercuric iodide, cadmium telluride, and lead iodide may be used.

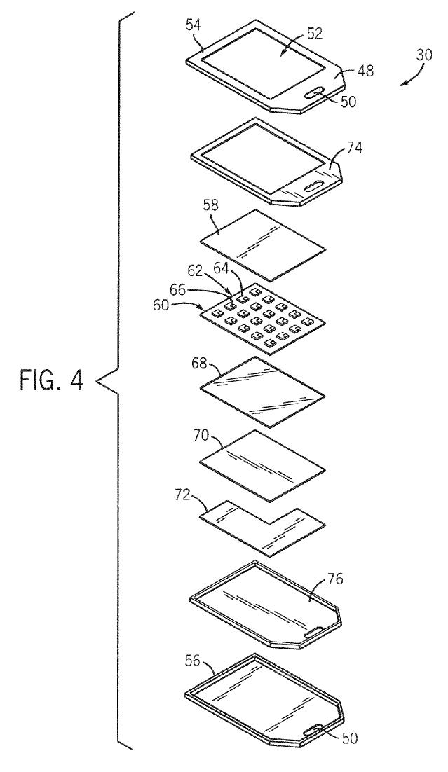

Referring now to FIG. 4, an exploded view schematically illustrates the internal composition of detector 30. Detector 30 includes a top cover 54 that along with base cover 56 provides a shell or enclosure for its internal components. Both covers 54, 56 are preferably formed of x-ray transparent composite material, such as graphite fiber-epoxy composite, so as to house and protect the detector components from fracture when exposed to a load or dropped. It is contemplated that, covers 54 and 56 may be constructed with bumpers, foam inserts, layers of impact absorbing material, and the like to inhibit fracturing of the detector components when dropped or exposed to a load. When assembled, the top cover 54 is constructed in such a manner that the detector may be placed on a floor and support a standing subject. In this regard, the top cover panel 54 is designed to minimally deflect when subjected to a load. Additionally, in one alternate embodiment, top cover 54 is formed of x-ray transparent material(s), but bottom cover 56 is formed of x-ray absorbent material(s).

Top cover 54 and base cover 56 collectively form handle 50 when assembled. The handle supports portability of the detector. Additionally, the detector is constructed to be quickly detached from a tether (not shown) that is used to connect the detector to the scanner during data acquisition and readout. As such, detector 30 may be transported to and from multiple scan stations remote from one another. This is particularly advantageous for emergency rooms and other triage facilities. Further, the portability and detachability of the detector further enhances the mobility of a mobile x-ray imaging system, such as that shown in FIG. 1.

Detector 30 further includes a scintillator layer 58 designed to convert incident x-rays or gamma rays to visible light. Scintillator layer 58, which may be fabricated from CsI or other scintillating material, is designed to emit light proportional to the number and energy of the x-rays received. As such, light emissions will be higher in those regions of the scintillator layer 58 where either more x-rays were received or the energy level of the received x-rays was higher. Since the composition of the subject will attenuate the x-rays projected by the x-ray tube, the energy level of the x-rays impinging upon the scintillator layer will not be uniform across the scintillator layer. This variation in light emission will be used to capture contrast in the reconstructed image.

The light emitted by the scintillator layer 58 is detected by detector elements of a detector element array 60. Each detector element 62 corresponds to a picture element or pixel in the reconstructed image. Each detector element 62 includes a light sensitive or photoconductive region 64 and an electronics region 66. During exposure to x-rays, electrons are released in the light sensitive region 64 in proportion to the light detected in the region 64. The electronics region 66 includes a capacitor (not shown) that stores the electrical charge accumulated by the light sensitive region. After exposure, a thin-film-transistor (not shown) in the electronics region 66 is biased so as to connect the capacitor to readout electronics in the x-ray scanner. Generally, a multiplexer (not shown) is used to control read out of the discrete detector elements in a sequential, raster fashion. In this regard, the output of each detector element is sequentially input to a digitizer for digitization for subsequent image reconstruction.

The thin-film-transistors of the detector elements 62 are supported by a glass substrate 68. Lead lines (not shown) etched in substrate 68 are used for routing of the electrical output of the detector elements as well as applying the biasing voltages to the thin-film-transistors. The glass substrate is generally very thin and fragile. In this regard, as referenced above, the top cover and base cover 54 and 56 are designed with impact absorbing material to help prevent fracturing of the glass substrate. Additionally, as the detector 30 may be used to support a relatively large load during imaging, e.g. imaging of the feet of an average sized adult male, the top cover panel 54 is further designed to reduce the stress on the detector to further prevent fracturing of the glass substrate and other detector components.

The glass substrate 68 is supported by a thin and lightweight detector panel support 70. Panel support 70 is preferably constructed to include radiation absorbing material in addition to structurally supporting material. Incorporating radiation absorbing material within the panel support reduces or eliminates the detection of backscattered x-ray. That is, the radiation absorbing material absorbs x-rays passing through the scintillator layer, detector element array, and glass substrate, as well as x-rays that deflect off the back cover of the detector.

Electronics board 72 lies outside the footprint of the glass substrate 68 and panel support 70, and supports the processing and logic control electronics of the detector. The electronics preferably include LEDs for monitoring operation and diagnostics of the detector. The motherboard may also include temperature sensors for providing feedback as to the temperature of the detector as well as the temperature of the subject. The electronics may also support an accelerometer designed to detect acceleration of the detector and store data accordingly. In this regard, the accelerometer may be used to record the date and time when the detector experienced dramatic increases in acceleration, i.e. when dropped. The electronics may also include various storage devices including flash storage. In a wireless implementation, the motherboard may include an antenna and transceiver for wirelessly transmitting data to the x-ray scanner. Additionally, the electronics may include a battery or other DC power source for powering the detector electronics. The electronics board also includes the readout electronics that control the readout of the electrical charge from electronics region 66 of detector array 60. Preferably, the panel support plate extends beyond the detector panel and the electronics are attached to the panel support. Since there are many electrical connections between the panel and the electronics, attaching them to the same panel support plate reduces stress on the interconnects.

As described above, the x-ray detector is designed to withstand relatively high-energy impacts, stresses, and strains such that the relatively sensitive components, i.e. scintillator layer, detector element array, glass substrate, and motherboard, are not damaged when the detector is dropped or stepped upon. In this regard, in one embodiment, the x-ray detector 30 includes two layers of impact-absorbing material 74, 76. One layer 74 is sealed against or otherwise placed in proximity to the undersurface of top cover panel 54 so as to be sandwiched between the top cover panel and scintillator layer 58. The other layer 76 is sealed or otherwise placed in proximity to the top surface of base panel 56 so as to be sandwiched between motherboard 72 and base panel 56. While two impact-absorbing layers 74, 76 are shown, it is contemplated that the detector may include only a single layer which is preferably sealed against the undersurface of top cover panel 54 or multiple layers interstitially disposed between the detector components. In this regard, the impact-absorbing material is designed not to attenuate radiation and, as such, does not interfere with data acquisition.

The impact-absorbing material is preferably an elastic material that is designed to absorb the shock and vibrations placed on the detector when dropped but also deflect the force placed on the detector when stepped upon or otherwise subjected to a load, e.g. a standing patient for a foot/feet scan. In this regard, the impact absorbing material will deform when subjected to a load, but also recover its shape when the load is removed.

The elastic material, which may be foam or other plastic, is designed to deflect and absorb stresses and strains on the detector. As such, when the detector is stepped upon or dropped, the internal components of the detector, e.g. scintillator layer, detector element array, glass substrate, and motherboard, do not fracture or are otherwise damaged. One skilled in the art will appreciate that the thickness, density and composition of the impact-absorbing material may be variably selected to define the limits by which the detector may be subjected to a load or dropped without damage to the detector components.

Further, it is contemplated that layers 74 and 76 can have similar or dissimilar thicknesses, and be composed of similar or dissimilar impact absorbing material(s). For example, layer 74 may be designed to be more absorbent and deflective than layer 76. In this regard, layer 74 may be thicker than layer 76 or formed from material with improved absorption and deflective characteristics. Additionally, layer 74 may be formed of foam having pronounced elastic properties whereas layer 76 is formed of polyurethane, PVC, or other material with less pronounced elastic characteristics.

Referring again to FIG. 4, to further enhance its resistance to fracturing loads, the x-ray detector 30 also includes two layers of soft foam 78, 80 that encase the scintillator layer 58, the detector element array 60, the glass substrate 68, and the panel support 70, that collectively define an imaging panel. Preferably, the foam layers 78 and 80 are formed of an elastomeric or other rubber-like composite and are sized to match the footprint of the imaging panel. In this regard, foam layers 78 and 80 provide a soft foam core for the imaging panel of the detector so as to disperse the impact of point loads placed on the detector.

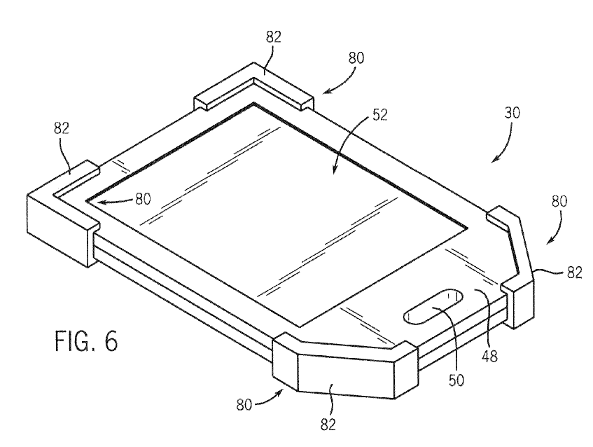

Referring now to FIG. 5, a cross-sectional view of an x-ray detector according to an alternate embodiment of the present invention is shown. In this embodiment, the cover assembly 54, 56 and impact-absorbing layers 74, 76 are respectively integrated. In this regard, the cover assembly components 54 and 56 each have a foam core 74 and 76, respectively, of impact absorbing material. Preferably, the integrated impact-absorbing layers are formed of stiff, but lightweight foam core, graphite fiber-epoxy composite. Additionally, in contrast to the embodiment of FIG. 4, the cover assembly components 54 and 56 are not symmetrical. That is, as shown in FIG. 5, the foam core 74 of top cover 54 extends laterally across the entirety of the x-ray detector structure, but the foam core 76 of the bottom cover 56 does not. The absence of foam core 76 beneath electronics 72 allows for dissipation of heat generated by the electronics to the base cover 56. In this regard, the base cover 56 absorbs and dissipates the heat generated by the detector electronics.

As shown, electronics 72 may include multiple boards 72(a) and 72(b), that are arranged outside the footprint of the imaging panel (collectively comprised of components 58, 60, 68, and 70). While only two boards are shown, it is contemplated that a single board or more than two boards may be used. By positioning the circuit boards 72(a) and 72(b) outside the footprint of the imaging panel, backscatter imaging of the circuit boards is eliminated. Moreover, the thickness of the detector is reduced. In one embodiment, the detector 30 has a thickness of 16 millimeters.

Therefore, an x-ray detector is disclosed. The detector includes an imaging panel configured to output electrical signals in response to reception of x-rays and a pair of shock absorbent layers with the imaging panel sandwiched therebetween. A cover assembly is provided for enclosing the imaging panel and the pair of shock absorbent layers.

The present invention also includes a solid state x-ray detector having a scintillator layer configured to output light in response to x-ray exposure and an array of photosensitive detector elements supported by a glass substrate and configured to store electrical charge as a function of light output by the scintillator layer during data acquisition and output electrical signals indicative of the stored electrical charge during readout. The detector further includes a readout electronics board situated outside a footprint of the glass substrate and operatively coupled to the array of photosensitive detector elements.

A cover assembly to encase components of an x-ray detector is also presented. The cover assembly has a top support panel and a bottom support panel. The cover assembly further has an imaging pane formed on the top support panel. The imaging pane defines a perimeter region and a central region of the top support panel. And, at least one of the top support panel and the bottom support panel is formed of x-ray transparent, graphite fiber-epoxy composite that is thicker in the perimeter region than in the central region.

The present invention has been described in terms of the preferred embodiment, and it is recognized that equivalents, alternatives, and modifications, aside from those expressly stated, are possible and within the scope of the appending claims.

What is claimed is:

1. An x-ray detector comprising:
an imaging panel configured to output electrical signals in response to reception of x-rays;
a pair of shock absorbent layers with the imaging panel sandwiched therebetween; and
a cover assembly enclosing the imaging panel and the pair of shock absorbent layers.

2. The x-ray detector of claim 1 wherein the cover assembly includes a handle to support portability thereof and is formed of x-ray transparent, graphite fiber-expoxy composite.

3. The x-ray detector of claim 1 wherein the cover assembly is at least partially formed of impact-absorbing material.

4. The x-ray detector of claim 3 wherein a perimeter region of the cover assembly is formed of thicker impact-absorbing material than non-perimeter regions.

5. The x-ray detector of claim 4 wherein the cover assembly includes an imaging window that is indicative of a footprint of imaging panel and wherein the imaging window demarcates the perimeter region from the non-perimeter regions.

6. The x-ray detector of claim 5 further comprising a circuit board having a plurality of electronic components disposed thereon and configured to at least control readout of the electrical signals from the imaging panel and wherein the circuit board is positioned in the perimeter region of the cover assembly.

7. The x-ray detector of claim 6 wherein at least one of the pair of shock absorbent layers is sized to match a surface area of the imaging panel.

8. The x-ray detector of claim 7 wherein the pair of shock absorbent layers is formed of elastomeric foam material.

9. The x-ray detector of claim 1 wherein the imaging panel comprises an x-ray detection layer, a scintillator layer, a photosensitive layer configured to detect illumination of the scintillator layer, and a glass substrate having transistors etched thereon and configured to control operation of the x-ray detection layer between a data acquisition state and a readout state.

10. The x-ray detector of claim 9 wherein the pair of shock absorbent layers is configured to transfer loads placed on the cover assembly therebetween.

11. The x-ray detector of claim 1 configured as a flat-panel, solid state x-ray detector.

12. A solid state x-ray detector comprising:
a scintillator layer configured to output light in response to x-ray exposure;
an array of photosensitive detector elements supported by a glass substrate and configured to store electrical charge as a function of light output by the scintillator layer during data acquisition and output electrical signals indicative of the stored electrical charge during readout; and
a readout electronics board situated outside a footprint of the glass substrate and operatively coupled to the array of photosensitive detector elements.

13. The solid state x-ray detector of claim 12 further comprising a pair of foam layers enclosing the scintillator layer, the array of photosensitive detector elements, and the glass substrate.

14. The solid state x-ray detector of claim 13 wherein the pair of foam layers has a footprint sized to match that of the glass substrate.

15. The solid state x-ray detector of claim 12 further comprising a housing formed of a rigid foam core composite.

16. The solid state x-ray detector of claim 15 wherein the housing comprises a handle.

17. The solid-state detector of claim 15 wherein the rigid foam core composite includes x-ray transparent, graphite fiber-epoxy component.

18. The solid state x-ray detector of claim 17 wherein the x-ray transparent graphite fiber-epoxy composite is thicker in the footprint of the glass substrate than outside the footprint of the glass substrate.

19. A cover assembly to encase components of an x-ray detector, the cover assembly comprising:
a top support panel and a bottom support panel;
an imaging pane formed on the top support panel, the imaging pane defining a perimeter region and a central region of the top support panel; and
at least one of the top support panel and the bottom support panel formed of x-ray transparent, graphite fiber-epoxy composite that is thicker in the perimeter region than in the central region.

20. The cover assembly of claim 19 wherein the imaging pane defines a footprint for an imaging panel.

21. The cover assembly of claim 19 wherein the top support panel and the bottom support panel are formed of impact-absorbing material.

22. The cover assembly of claim 19 wherein the top support panel and the bottom support panel when coupled together define an internal volume sized to snuggly receive two layers of foam enclosing an imaging panel.

23. The cover assembly of claim 19 further comprising a handle defined in the top support panel and the bottom support panel.
